(19) United States
(12) Patent Application Publication
(10) Pub. No.: US 2025/0245142 A1
(43) Pub. Date: Jul. 31, 2025

(54) STORAGE CIRCUIT, CONTROL METHOD AND CONTROL CHIP

(71) Applicant: Nuvoton Technology Corporation, Hsinchu Science Park (TW)

(72) Inventor: Chun-Chi CHEN, Tainan City (TW)

(21) Appl. No.: 19/011,987

(22) Filed: Jan. 7, 2025

(30) Foreign Application Priority Data
Jan. 29, 2024 (TW) 113103322

(51) Int. Cl. G06F 12/02

(52) U.S. Cl. CPC G06F 12/0223

(57) ABSTRACT

A storage circuit including a memory and a control circuit is provided. The memory includes a memory block and a backup block. The memory block stores a plurality of data sets. The control circuit receives an erase request. In response to the erase request selecting at least one of the data sets, the control circuit erases the backup block, copies all data sets that are not selected by the erase request to the backup block from the memory block, and activates the backup block to replace the memory block. After activating the backup block, the control circuit accesses the backup block in response to an access request pointing to the memory block.

### CROSS REFERENCE TO RELATED APPLICATIONS

This application claims priority of Taiwan Patent Application No. 113103322, filed on Jan. 29, 2024, the entirety of which is incorporated by reference herein.

### BACKGROUND OF THE INVENTION

### Field of the Invention

The present invention relates to storage circuit, and, in particular, to a storage circuit that can erase a specific data set from a specific page.

### Description of the Related Art

Generally, electronic devices usually have a memory to store many settings, such as voltage settings. Since the erase operation of the memory erases an entire page at a time, the conventional technology is to store the same type of attributes in the same page, but this results in a decrease in memory utilization, wastes storage space, and increases costs.

### BRIEF SUMMARY OF THE INVENTION

In accordance with an embodiment of the disclosure, a storage circuit comprises a memory and a control circuit. The memory comprises a memory block and a backup block. The memory block stores a plurality of data sets. The control circuit receives an erase request. In response to the erase request selecting at least one of the data sets, the control circuit erases the backup block, copies all data sets that are not selected by the erase request to the backup block from the memory block, and activates the backup block to replace the memory block. After activating the backup block, the control circuit accesses the backup block in response to an access request pointing to the memory block.

In accordance with another embodiment of the disclosure, a control chip comprises a master circuit, a bus circuit, and a storage circuit. The master circuit sends an erase request and an access request. The bus circuit is coupled to the master circuit to transmit the erase request and the access request. The storage circuit is coupled to the bus circuit and comprises a slave interface, a non-volatile memory, and a control circuit. The slave interface is coupled to the bus circuit to receive the erase request and the access request. The non-volatile memory comprises a memory block and a backup block. The memory block stores a plurality of data sets. The control circuit receives the erase request and the access request from the bus circuit via the slave interface. In response to the erase request selecting at least one of the data sets, the control circuit erases the backup block, copies all data sets that are not selected by the erase request to the backup block, and activates the backup block. In response to the backup block having been activated and the access request pointing to the memory block, the control circuit accesses the backup block.

A control method applied in a storage circuit is provided. The storage circuit comprises a first page and a second page. An exemplary embodiment of the control method is described in the following paragraph. A plurality of data sets are stored in the first page. In response to an erase request selecting at least one of the data sets, the second page is erased, all data sets that are not selected by the erase request are copied to the second page, and the second page is activated to replace the first page. In response to an access request pointing to the first page, the second page which has been activated is accessed.

The control method may be practiced by the systems which have hardware or firmware capable of performing particular functions and may take the form of program code embodied in a tangible media. When the program code is loaded into and executed by an electronic device, a processor, a computer or a machine, the electronic device, the processor, the computer or the machine becomes a storage circuit and a control chip for practicing the disclosed method.

### BRIEF DESCRIPTION OF THE DRAWINGS

The present invention can be more fully understood by reading the subsequent detailed description and examples with references made to the accompanying drawings, wherein:

FIG. 1 is a schematic diagram of an exemplary embodiment of a control chip according to various aspects of the present disclosure.

FIG. 2 is a schematic diagram of an exemplary embodiment of a storage circuit according to various aspects of the present disclosure.

FIGS. 3A-3D are schematic diagrams of exemplary embodiments of the operations of the storage circuit according to various aspects of the present disclosure.

FIG. 4 is a flowchart of a control method in accordance with an embodiment of the present disclosure.

### DETAILED DESCRIPTION OF THE INVENTION

The present invention will be described with respect to particular embodiments and with reference to certain drawings, but the invention is not limited thereto and is only limited by the claims. The drawings described are only schematic and are non-limiting. In the drawings, the size of some of the elements may be exaggerated for illustrative purposes and not drawn to scale. The dimensions and the relative dimensions do not correspond to actual dimensions in the practice of the invention.

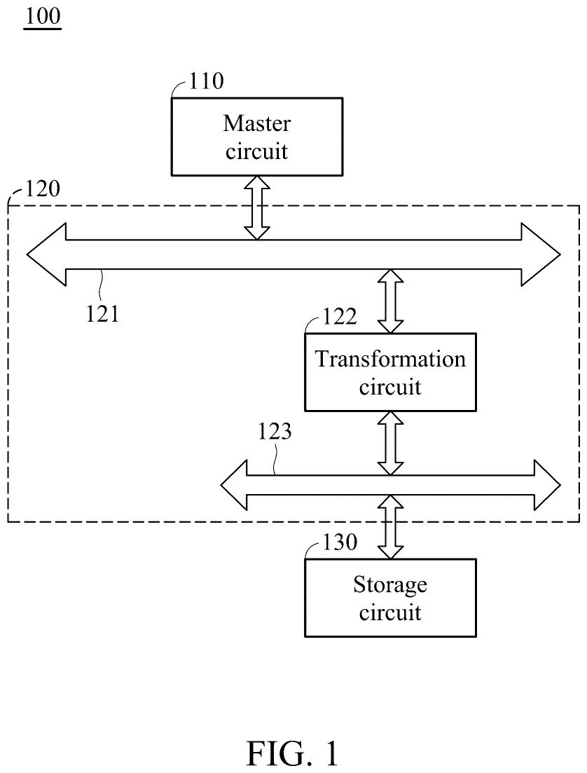

FIG. 1 is a schematic diagram of an exemplary embodiment of a control chip according to various aspects of the present disclosure. As shown in FIG. 1, the control chip 100 comprises a master circuit 110, a bus circuit 120, and a storage circuit 130. The master circuit 110 erases or accesses the data stored in the storage circuit 130 via the bus circuit 120. In one embodiment, the master circuit 110 sends an erase request to the storage circuit 130 via the bus circuit 120 to delate corresponding data in the storage circuit 130. In another embodiment, the master circuit 110 sends an access request to the storage circuit 130 via the bus circuit 120. The storage circuit 130 provides corresponding data to the master circuit 110 or stores data from the master circuit 110.

The number of master circuit is not limited in the present disclosure. In other embodiment, the control chip 110 comprises the more master circuits. Additionally, the kind of master circuit 110 is not limited in the present disclosure. In one embodiment, the master circuit 110 is a Central Processing Unit (CPU) or a Neural-network Processing Unit (NPU).

The bus circuit 120 is coupled between the master circuit 110 and the storage circuit 130 to transmit signals and data. For example, the bus circuit 120 may transmit the erase request and the access request to the storage circuit 130 from the master circuit 110 or transmit the output from the storage circuit 130 to the master circuit 110. The structure of bus circuit 120 is not limited in the present disclosure. In one embodiment, the bus circuit 120 comprises an Advanced eXtensible Interface (AXI) transmission circuit 121, a transformation circuit 122, and an Advanced High performance Bus (AHB) transmission circuit 123.

The AXI transmission circuit 121 is coupled between the master circuit 110 and the transformation circuit 122. The transformation circuit 122 performs a transformation operation between an AXI protocol and an AHB protocol. For example, the transformation circuit 122 may transform the signal provided by the AXI transmission circuit 121 from the AXI protocol to the AHB protocol and then provide the transformed result to the AHB transmission circuit 123. In another embodiment, the transformation circuit 122 transforms the signal provided by the AHB transmission circuit 123 from the AHB protocol to the AXI protocol and then provides the transformed result to the AXI transmission circuit 121. The AHB transmission circuit 123 is coupled between the transformation circuit 122 and the storage circuit 130.

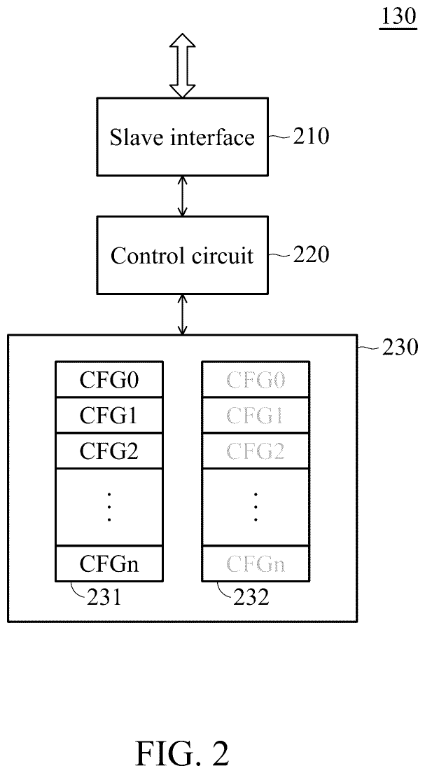

The storage circuit 130 is coupled to the bus circuit 120 and operates according to the request sent from the master circuit 110. FIG. 2 is a schematic diagram of an exemplary embodiment of the storage circuit 130 according to various aspects of the present disclosure. The storage circuit 130 comprises a slave interface 210, a control circuit 220, and a memory 230. The slave interface 210 is coupled to the bus circuit 120 to receive the erase request and the access request from the master circuit 110.

The control circuit 220 is coupled between the slave interface 210 and the memory 230 and accesses the memory 230 according to the request from the master circuit 110. The type of memory 230 is not limited in the present disclosure. In one embodiment, the memory 230 is a non-volatile memory, such as a ROM or a flash. In another embodiment, the memory 230 is a volatile memory, such as a RAM.

The memory 230 comprises a memory blocks 231 and 232, but the disclosure is not limited thereto. In other embodiments, the memory 230 comprises the more memory block. In some embodiments, each memory block is a page. For example, the memory block 231 is a first page, and the memory block 232 is a second page. In another embodiment, each memory block comprises the more pages.

The control circuit 220 writes data into the memory block 231 or 232 according to the access request of the master circuit 110. Assume that the memory block 231 is a valid block. In this case, the control circuit 220 writes the data sets CFG0˜CFGn to the memory block 231. The number of bits of each data set is not limited in the present disclosure. In one embodiment, the data sets CFG0˜CFGn have the same number of bits, such as one word. In another embodiment, the number of bits of at least one of the data sets CFG0˜CFGn is different from that of another of the data sets CFG0˜CFGn.

When an erase request selects at least one (e.g., CFG1) of the data sets CFG0˜CFGn, the control circuit 220 erases the memory block 232 and copies all data sets (CFG0, CFG2˜CFGn) that are not selected by the erase request to the memory block 232. After finishing the copying operation, the control circuit 220 activates the memory block 232 and uses the memory block 232 to replace the memory block 231.

After the memory block 232 has been activated, when an access request points to the memory block 231, the control circuit 220 accesses the memory block 232. For example, when the access request points to the data set CFG0 of the memory block 231, the control circuit 220 accesses the data set CFG0 of the memory block 232 and outputs the data set CFG0 of the memory block 232 to the slave interface 210. When the access request wants to write external data into the memory block 231, the control circuit 220 writes the external data into the memory block 232. In this embodiment, the control circuit 220 copies the data sets of the memory block 231 (except the data sets selected by the erase request) to the memory block 232, so the memory block 232 is referred to as a backup block.

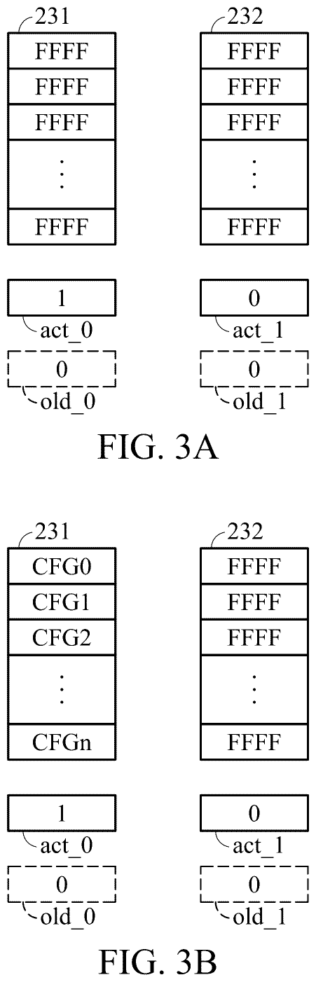

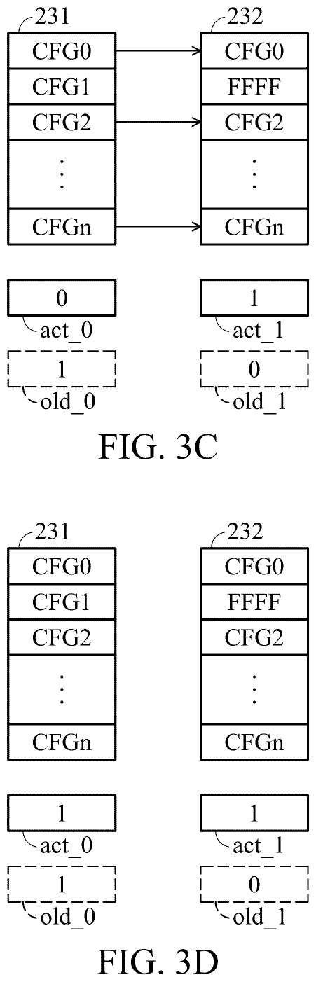

FIGS. 3A-3D are schematic diagrams of exemplary embodiments of the operations of the storage circuit according to various aspects of the present disclosure. Refer to FIG. 3A, in an initial period, the control circuit 220 erases the memory blocks 231 and 232. For example, after a mass erase operation, each memory unit of the memory blocks 231 and 232 stores the value FFFF. In some embodiments, the control circuit 220 adjusts the value of an activation flag act_0 according to the initial setting so that the value of the activation flag act_0 is equal to the value 1, which may be referred to as a specific value. It means that the memory block 231 is a valid block. Additionally, the control circuit 220 adjusts the value of the activation flag act_1 according to the initial setting so that the value of the activation flag act_1 is equal to the value 0. When the value of the activation flag act_1 is equal to the value 0, it indicates that the memory block 231 is an invalid block. In one embodiment, the master circuit 110 writes the initial setting to the control circuit 220 via the bus circuit 120.

Refer to FIG. 3B, when an access request directs the control circuit 220 to store the data sets CFG0˜CFGn, since the memory block 231 is a valid block, the control circuit 220 writes the data sets CFG0˜CFGn to the memory block 231. When the control circuit 220 receives an erase request and the erase request selects the data sets CFG1, the control circuit 220 erases the memory block 232 to avoid data from remaining in the memory block 232.

Refer to FIG. 3C, after erasing the memory block 232, the control circuit 220 performs a backup operation to back up all data sets CFG0 and CFG2˜CFGn except the data set CFG1 to the memory block 232 and activates the memory block 232. Since the control circuit 220 erases the memory block 232 in advance, so it can prevent the remaining data in the memory block 232 from affecting the data sets CFG0 and CFG2˜CFGn.

After completing the backup operation, the control circuit 220 adjusts the value of the activation flag act_1 so that the value of the activation flag act_1 is equal to the value 1. When the value of the activation flag act_1 is equal to the value 1, it indicates that the memory block 232 is a valid block. In addition, after completing the backup operation, the control circuit 220 adjusts the value of the activation flag act_0 so that the value of the activation flag act_0 is equal to the value 0. In this case, before the backup operation is completed, the value of the activation flag act_0 is equal to the value 1.

In this embodiment, the memory block 232 stores all data sets CFG0 and CFG2˜CFGn except the data set CFG1, which is equivalent to erase the data set CFG1. Since the control circuit 220 does not need to erase all the data sets of the memory block 231, the number of erasures of the memory block 231 can be reduced and the life of the memory block 231 can be increased. Therefore, when an access request points to the memory block 231, since the value of the activation flag act_1 is equal to a specific value, the control circuit 220 accesses the memory block 232. In other embodiments, when an access request points to the memory block 231, if the value of the activation flag act_1 is not equal to the specific value and the value of the activation flag act_0 is equal to the specific value, the control circuit 220 accesses the memory block 231.

The status of activation flags act_0 and act_1 is shown in Table 1 below:

TABLE 1

| act_0 | act_1 | Valid block | report |
|---|---|---|---|
| 0 | 0 | 231 | error |
| 0 | 1 | 232 | correct |
| 1 | 0 | 231 | correct |
| 1 | 1 | 231 | error |

When the values of the activation flags act_0 and act_1 are 00, it indicates that an abnormal event occurs, for example, the mass erase operation of the control circuit 220 fails. Therefore, the control circuit 220 reports an error message to the master circuit 110 and serves the memory block 231 as a valid block.

In one embodiment, when an abnormal event occurs, the control circuit 220 rejects the access requests which are not provided by the control chip 100. For example, the control chip 100 comprises a debug interface (not shown) to be coupled to a debug device (not shown). In response to an occurrence of an abnormal event, the control circuit 220 rejects any command from the debug device.

When the values of the activation flags act_0 and act_1 are 01, it indicates that all data sets that are not selected by the erase request have been copied to the memory block 231 by the control circuit 220. Therefore, the control circuit 220 serves the memory block 232 as a valid block. When an access request points to the memory block 231, the control circuit 220 accesses the memory block 232. In this case, the memory block 231 is replaced with the memory block 232. Although the data sets of the memory block 231 are held, the control circuit 220 does not access the data sets stored in the memory block 231.

When the values of the activation flags act_0 and act_1 are 10, it indicates that the control circuit 220 has not copied the data sets to the memory block 232. Therefore, the control circuit 220 adjusts the activation flag act_1 so that the value of the activation flag act_1 is equal to the value 0. The control circuit 220 serves the memory block 231 as a valid block. When an access request points to the memory block 231, the control circuit 220 accesses the memory block 231.

When the values of the activation flags act_0 and act_1 are 11, it indicates that an abnormal event occurs. For example, before the control circuit 220 changes the value of the activation flag act_0 from the value 1 to the value 0, an interruption event (such as a power was interrupted) occurs. Therefore, the control circuit 220 reports an error message to the master circuit 110 and serves the memory block 231 as a valid block.

In some embodiments, when an access request points to the memory block 231, the control circuit 220 accesses a valid block (the memory block 231 or 232). For example, when the memory block 231 is a valid block, the control circuit 220 accesses the memory block 231 according to the access request. The control circuit 220 may write data into the memory block 231 or provide the data stored in the memory block 231. However, when the memory block 232 is a valid block, the control circuit 220 accesses the memory block 232 according to the access request. The control circuit 220 may write data into the memory block 232 or provide the data sets stored in the memory block 232.

In other embodiments, the control circuit 220 further adjusts page flags old_0 and old_1. Refer to FIG. 3A, in the initial period, after the control circuit 220 erases the memory blocks 231 and 232, the control circuit 220 adjusts the values of the page flags old_0 and old_1 so that the values of the page flags old_0 and old_1 are equal to the value 0.

Refer to FIG. 3B, after the data sets CFG0˜CFGn have been written into the memory block 231 by the control circuit 220, the control circuit 220 does not change the values of the page flags old_0 and old_1.

Refer to FIG. 3C, after the control circuit 220 copies the data sets CFG0 and CFG2˜CFGn to the memory block 232, the control circuit 220 adjusts the value of the page flag old_0 so that the value of the page flag old_0 is equal to the value 1 which indicates the memory block 231 is an old block. The control circuit 220 maintains the value of the page flag old_1 at the value 0. In some embodiment, when the data sets CFG0 and CFG2˜CFGn have been copied into the memory block 232 by the control circuit 220, the control circuit 220 adjusts the value of the page flag old_0 so that the value of the page flag old_0 is equal to the value 1 and then adjusts the value of the value of the activation flag act_1 so that the value of the activation flag act_1 is equal to the value 1.

Refer to FIG. 3D, after the value of the activation flag act_1 is equal to the value 1, the control circuit 220 maintains the value of activation flag act_0 at the value 1. In this case, even if the value of the activation flag act_0 is equal to the value 1, since the value of the page flag old_0 is equal to the value 1, it indicates that the memory block 231 is an old block. Therefore, the control circuit 220 does not access the memory block 231. At this time, the value of the activation flag act_1 is equal to the value 1, it means that the memory block 232 is a valid block. Therefore, when an access request points to the memory block 231, the control circuit 220 uses the memory block 232 to replace the memory block 231.

The status of activation flags act_0 and act_1 and the page flags old_0 and old_1 is shown in Table 2A below:

TABLE 2A

| act_0 | old_0 | act_1 | old_1 | Valid block | report |
|---|---|---|---|---|---|
| 0 | 0 | 0 | 0 | 231 | error |
| 0 | 0 | 0 | 1 | 231 | error |
| | | | | | (no exist) |
| 0 | 0 | 1 | 0 | 232 | correct |
| 0 | 0 | 1 | 1 | 232 | correct |
| 0 | 1 | 0 | 0 | 231 | error |
| | | | | | (no exist) |
| 0 | 1 | 0 | 1 | 231 | error |
| | | | | | (no exist) |
| 0 | 1 | 1 | 0 | 232 | correct |
| | | | | | (no exist) |
| 0 | 1 | 1 | 1 | 232 | correct |
| | | | | | (no exist) |

When the values of the activation flags act_0 and act_1 are 00, it indicates that an abnormal event occurs, for example, the power of the storage circuit 130 was interrupted. Additionally, when the mass-erase operation of the control circuit 220 fails, the values of the activation flags act_0 and act_1 may be 00. Therefore, the control circuit 220 reports an error message to the master circuit 110 and serves the memory block 231 as a valid block.

When the values of the activation flags act_0 and act_1 are 01, it indicates that the memory block 231 stores valid data sets. Therefore, the control circuit 220 ignores the values of the page flags old_0 and old_1 and serves the memory block 232 as a valid block.

In some embodiments, after the mass-erase operation, the control circuit 220 first adjusts the value of the activation flag act_0 corresponding to the memory block 231 so that the value of the activation flag act_0 is equal to the value 1 and the memory block 231 is served as a main block. At this time, when an erase request selects specific data set (e.g., the data set CFG1) stored in the memory block 231, the control circuit 220 backs up all data sets (such as CFG0, CFG2˜CFGn) except the specific data set to the memory block 232. After finishing the back-up operation, the control circuit 220 first adjusts the value of the page flag old_0 corresponding to the memory block 231 so that the value of the page flag old_0 is equal to the value 1. When the value of the page flag old_0 is equal to the value 1, it indicates the memory block 231 is an old block. Then, the control circuit 220 adjusts the value of the activation flag act_1 corresponding to the memory block 232 so that the value of the activation flag act_1 is equal to the value 1. In this case, the values of the activation flag act_0, the page flag old_0 and the activation flag act_1 are successively set to the value 1. When the value of the activation flags act_0 is equal to the value 0, the values of the page flags old_0 and old_1 are not equal to the value 1. Therefore, there is no situation where the values of the activation flag act_0, the page flag old_0, the activation flag act_1 and the page flag old_1 are 0001, 0100, 0101, 0110 and 0111 in the table 2A.

In other embodiments, the status of activation flags act_0 and act_1 and the page flags old_0 and old_1 is shown in Table 2B below:

TABLE 2B

| act_0 | old_0 | act _1 | old_1 | Valid block | report |
|---|---|---|---|---|---|
| 1 | 0 | 0 | 0 | 231 | correct |
| 1 | 0 | 0 | 1 | 231 | correct |
| | | | | | (no exist) |
| 1 | 0 | 1 | 0 | 231 | error |
| 1 | 0 | 1 | 1 | 231 | correct |
| 1 | 1 | 0 | 0 | 231 | correct |
| 1 | 1 | 0 | 1 | 231 | correct |
| | | | | | (no exist) |
| 1 | 1 | 1 | 0 | 232 | correct |
| 1 | 1 | 1 | 1 | 231 | error |
| | | | | | (no exist) |

When the values of the activation flags act_0 and act_1 are 11, the control circuit 220 reads the values of the page flags old_0 and old_1. In one embodiment, if the value of the page flag old_0 is equal to the value 0, it means that an interruption event occurs. Therefore, the control circuit 220 does not set the value page flag old_0 to the value 1. The control circuit 220 reports an error message and serves the memory block 231 as a valid block. In another embodiment, when the values of the page flags old_0 and old_1 are 11, it means an occurrence of an abnormal event. Therefore, the control circuit 220 reports an error message and serves the memory block 231 as a valid block. In other embodiments, when the values of the page flags old_0 and old_1 are 10, it means that the memory block 231 is an old block. Therefore, the control circuit 220 serves the memory block 232 as a valid block. In this case, when an access request points to the memory block 231, the control circuit 220 accesses the memory block 231.

When the values of the activation flags act_0 and act_1 are 10, it indicates that the memory block 231 has not yet store valid data. Therefore, the control circuit 220 serves the memory block 231 as a valid block. When the values of the activation flags act_0 and act_1 are 11, if the values of the page flags old_0 and old_1 are 10, it means that the memory block 231 is an old block. Therefore, the control circuit 220 serves the memory block 232 as a valid block. However, when the values of the activation flags act_0 and act_1 are 10, if the values of the page flags old_0 and old_1 are 11, it means that the memory block 232 is an old block. Therefore, the control circuit 220 serves the memory block 231 as a valid block.

In some embodiments, when the value of an activation flag (e.g., act_0 or act_1_ is equal to the value 0, it means that the corresponding memory block (e.g., 231 or 232) has not been activated by the control circuit 220. For example, when the value of the activation flag act_1 is equal to the value 0, the control circuit 220 does not access the memory block 232 which corresponds to the activation flag act_1. The control circuit 220 does not set the value of the page flag old_1 corresponding to the memory block 232 so that the value of the page flag old_1 is equal to the value 0. Therefore, there is no situation where the values of activation flag act_1 and page flag old_1 are 01. In addition, there is no case where the values of page flags old_0 and old_1 are 11.

The control circuit 220 determines an occurrence of an abnormal event according to the values of the activation flags act_0 and act_1. When an abnormal event occurs, the control circuit 220 accesses the original memory block (e.g., 231) to ensure that the operation of the control chip 100 is normal. Furthermore, the control circuit 220 may activate a protection function to reject access commands which are not sent by the control chip 100

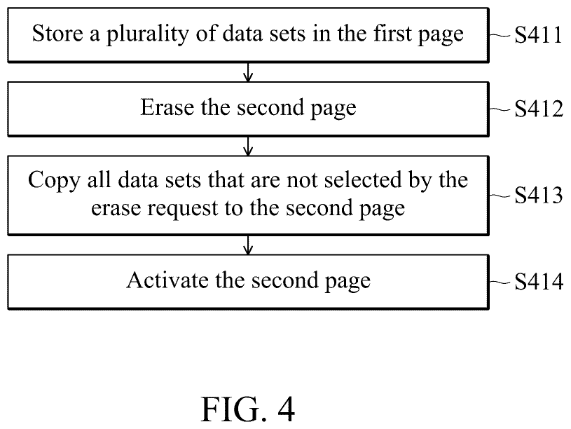

FIG. 4 is a flowchart of a control method in accordance with an embodiment of the present disclosure. The control method may take the form of a program code. When the program code is loaded into and executed by a machine, the machine thereby becomes a storage circuit and a control chip for practicing the control method. In one embodiment, the control method is applied in a storage circuit. The storage circuit comprises a first page and a second page.

First, a plurality of data sets are stored in the first page (step S411). The length of each data set is not limited in the present disclosure. In one embodiment, each data set has the same data length, such as one word. In another embodiment, the data length of at least one of the data sets is different from the data length of another data set. In some embodiments, since the second page has not yet stored valid data, step S411 is performed to adjust the first activation flag so that the value of the first activation flag is not equal to a specific value. Since the first page stores valid data, step S411 is performed to adjust the second activation flag so that the value of the second activation flag is equal to the specific value. In this case, the first activation flag corresponds to the second page, and the second activation flag corresponds to the first page.

Next, when an erase request selects at least one of the data sets, the second page is erased (step S412) and then all data sets that are not selected by the erase request are copied to the second page (step S413). Taking FIG. 3C as an example, assume that an erase request selects the data set CFG1, step S413 is performed to copy the data sets CFG0 and CFG2˜CFGn other than the data set CFG1 to the second page. Since the data set CFG1 is not stored in the second page, it can be considered that the data group CFG1 has been erased.

Next, the second page is activated to replace the first page (step S414). In one embodiment, since the second page is a new page and stores valid data, step S414 is performed to adjust the value of the first activation flag to that the value of the first activation flag is equal to a specific value. In this case, since the first page is an old page, step S414 is performed to adjust the value of the second activation flag so that the value of the second activation flag is not equal to the specific value. For example, step S414 is performed to adjust the value of the first activation flag from the value 0 to the value 1 and adjust the value of the second activation flag from the value 1 to the value 0.

In another embodiment, step S414 is performed to adjust the value of the page flag to the specific value to indicate that the first page is an old page. Then, step S414 is performed to adjust the value of the first activation flag to the specific value to indicate that the second page is a new page. In this case, step S414 may be performed to maintain the value of the second activation flag to the specific value. Since step S414 does not erase the value of the second activation flag, the number of times the second activation flag is erased can be reduced and no additional erasing time is required.

In some embodiments, when the value of the first activation flag is equal to the specific value, it indicates that the second page is a valid page. Therefore, after the second page is activated, when an access request points to the first page, the second page is accessed because the value of the first activation flag is equal to the specific value. However, when the value of the first activation flag is not equal to the specific value, it indicates that the first page is a valid page. Therefore, when an access request points to the first page, the first page is accessed.

In other embodiments, in an initial period, the first page is erased and the value of the second activation flag is set to the specific value according to the initial setting. Therefore, when the storage circuit receives an access request, the storage circuit writes external data (or referred to as data sets) to the first page.

In some embodiments, step S413 is performed to further set the value of the page flag to the specific value. In this case, after all data sets that are not selected by the erase request are copied to the second page, step S413 is performed to set the value of the page flag to the specific value and then set the value of the first activation flag to the specific value. In other embodiments, step S413 is performed to adjust the value of the second activation flag so that the value of the second activation flag is not equal to the specific value or maintain the value of the first activation flag to the specific value.

When an access request points to the first page, the storage circuit accesses the first or second page according to the values of the first and second activation flags. For example, when the value of the first activation flag is not equal to the specific value and the value of the second activation flag is equal to the specific value, it indicates that the first page is a valid page. Therefore, the storage circuit accesses the first page according to the access request. However, when the value of the first activation flag is equal to the specific value and the value of the second activation flag is not equal to the specific value, it indicates that the second page is a valid page. Therefore, the storage circuit accesses the second page.

In other embodiments, when an access request points to the first page and the values of the first and second activation flags are equal to the specific value, the storage circuit reads the value of the page flag. When the value of the page flag is equal to the specific value, it indicates that the first page is an old page and the second page is a new page. Therefore, the storage circuit accesses the second page according to the access request. However, when the value of the page flag is not equal to the specific value, it indicates that the first page is a new page. Therefore, the storage circuit accesses the first page.

Control method, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes a storage circuit and a control chip for practicing the methods. The methods may also be embodied in the form of a program code transmitted over some transmission medium, such as electrical wiring or cabling, through fiber optics, or via any other form of transmission, wherein, when the program code is received and loaded into and executed by a machine such as a computer, the machine becomes a storage circuit and a control chip for practicing the disclosed methods. When implemented on a general-purpose processor, the program code combines with the processor to provide a unique apparatus that operates analogously to application-specific logic circuits.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. It will be understood that although the terms “first,” “second,” etc. may be used herein to describe various elements, these elements should not be limited by these terms. These terms are only used to distinguish one element from another. In the following claims, the terms “first,” “second,” etc. are used merely as labels, and are not intended to impose numerical requirements on their objects.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A storage circuit, comprising:
a memory, comprising:
a memory block storing a plurality of data sets; and
a backup block; and
a control circuit receiving an erase request,
wherein:
in response to the erase request selecting at least one of the data sets:
the control circuit erases the backup block, copies all data sets that are not selected by the erase request to the backup block from the memory block, and activates the backup block to replace the memory block, and
after activating the backup block, the control circuit accesses the backup block in response to an access request pointing to the memory block.

2. The storage circuit as claimed in claim 1, wherein:
after copying all data sets that are not selected by the erase request to the backup block from the memory block, the control circuit adjusts a value of a first activation flag so that the value of the first activation flag is equal to a specific value, and
before copying all data sets that are not selected by the erase request to the backup block from the memory block, the control circuit adjusts the value of the first activation flag so that the value of the first activation flag is not equal to the specific value.

3. The storage circuit as claimed in claim 2, wherein:
in response to the access request pointing to the memory block and the value of the first activation flag being equal to the specific value, the control circuit accesses the backup block,
in response to the access request pointing to the memory block and the value of the first activation flag not being equal to the specific value, the control circuit accesses the memory block.

4. The storage circuit as claimed in claim 2, wherein:
after copying all data sets that are not selected by the erase request to the backup block from the memory block, the control circuit adjusts a value of a second activation flag so that the value of the second activation flag is not equal to the specific value, and
before copying all data sets that are not selected by the erase request to the backup block from the memory block, the value of the second activation flag is equal to the specific value.

5. The storage circuit as claimed in claim 4, wherein in an initial period, the control circuit erases the memory block and adjusts the value of the second activation flag according to an initial setting so that the value of the second activation flag is equal to the specific value.

6. The storage circuit as claimed in claim 5, wherein:
after copying all data sets that are not selected by the erase request to the backup block from the memory block, the control circuit adjusts a value of a page flag to the specific value and then adjusts the value of the first activation flag to the specific value.

7. The storage circuit as claimed in claim 6, wherein after copying all data sets that are not selected by the erase request to the backup block from the memory block, the control circuit maintains the value of the second activation flag so that the value of the second activation flag is equal to the specific value.

8. The storage circuit as claimed in claim 7, wherein in response to the access request pointing to the memory block:
the control circuit reads the values of the first and second activation flags,
in response to the value of the first activation flag not being equal to the specific value and the value of the second activation flag being equal to the specific value, the control circuit accesses the memory block, and
in response to the value of the first activation flag being equal to the specific value and the value of the second activation flag not being equal to the specific value, the control circuit accesses the backup block.

9. The storage circuit as claimed in claim 8, wherein:
in response to the access request pointing to the memory block and the values of the first and second activation flags being equal to the specific value, the control circuit reads the value of the page flag,
in response to the value of the page flag being equal to the specific value, the control circuit accesses the backup block, and
in response to the value of the page flag not being equal to the specific value, the control circuit accesses the memory block.

10. The storage circuit as claimed in claim 1, wherein the memory block is a first page, and the backup block is a second page.

11. A control method applied in a storage circuit comprising a first page and a second page, comprising:
storing a plurality of data sets in the first page;
in response to an erase request selecting at least one of the data sets:
erasing the second page;
copying all data sets that are not selected by the erase request to the second page; and
activating the second page to replace the first page; and
accessing the second page which has been activated in response to an access request pointing to the first page.

12. The control method as claimed in claim 11, further comprising:
adjusting a value of a first activation flag to a specific value after copying all data sets that are not selected by the erase request to the second page; and
adjusting the value of the first activation flag so that the value of the first activation flag is not equal to the specific value before copying all data sets that are not selected by the erase request to the second page.

13. The control method as claimed in claim 12, further comprising:
accessing the second page in response to the access request pointing to the first page and the value of the first activation flag being equal to the specific value; and
accessing the first page in response to the access request pointing to the first page and the value of the first activation flag not being equal to the specific value.

14. The control method as claimed in claim 12, further comprising:
adjusting a value of the second activation flag so that the value of the second activation flag is not equal to the specific value after copying all data sets that are not selected by the erase request to the second page,
wherein before copying all data sets that are not selected by the erase request to the second page, the value of the second activation flag is equal to the specific value.

15. The control method as claimed in claim 14, further comprising:
in an initial period:
erasing the first page; and
adjusting the value of the second activation flag to the specific value according to an initial setting.

16. The control method as claimed in claim 15, further comprising:
adjusting a value of a page flag to the specific value and then adjusting the value of the first activation flag to the specific value after copying all data sets that are not selected by the erase request to the second page.

17. The control method as claimed in claim 16, further comprising:
maintaining the value of the second activation flag to the specific value after copying all data sets that are not selected by the erase request to the second page.

18. The control method as claimed in claim 17, further comprising:
in response to the access request pointing to the first page:
reading the values of the first and second activation flags;
accessing the first page in response to the value of the first activation flag not being equal to the specific value and the value of the second activation flag being equal to the specific value;
accessing the second page in response to the value of the first activation flag being equal to the specific value and the value of the second activation flag not being equal to the specific value.

19. The control method as claimed in claim 18, further comprising:
in response to the access request pointing to the first page and the values of the first and second activation flag being equal to the specific value:
reading the value of the page flag;
accessing the second page in response to the value of the page flag being equal to the specific value; and
accessing the first page in response to the value of the page flag not being equal to the specific value.

20. A control chip comprising:
a master circuit sending an erase request and an access request;
a bus circuit coupled to the master circuit to transmit the erase request and the access request; and
a storage circuit coupled to the bus circuit and comprising:
a slave interface coupled to the bus circuit to receive the erase request and the access request;
a non-volatile memory comprising:
a memory block storing a plurality of data sets; and
a backup block; and
a control circuit receiving the erase request and the access request from the bus circuit via the slave interface,
wherein:
in response to the erase request selecting at least one of the data sets, the control circuit erases the backup block, copies all data sets that are not selected by the erase request to the backup block, and activates the backup block,
in response to the backup block having been activated and the access request pointing to the memory block, the control circuit accesses the backup block.
